(19) United States
(12) Patent Application Publication
(10) Pub. No.: US 2013/0306247 A1
(43) Pub. Date: Nov. 21, 2013

(54) One-Way Perforated vinyl (polyvinyl chloride) completed window screen with limited daylight privacy and with or without designed images (within and wrapped around the window screen frame)

(71) Applicant: Linda Carol Spurgers, Euless, TX (US)

(72) Inventor: Linda Carol Spurgers, Euless, TX (US)

(21) Appl. No.: 13/475,975

(22) Filed: May 19, 2012

(51) Int. Cl. E06B 9/24

(52) U.S. Cl. CPC E06B 9/24
USPC 160/12

(57) ABSTRACT

Improvements in a complete window screen with frame disclosed. The improvements disclosed are the use of One-Way Perforated Vinyl (polyvinyl chloride) window privacy film material as the inner perforated function within a window screen frame that is then attached to the window screen by inserting the material into an recessed groove indented in the window screen frame and is held to the window screen frame by the use of window screen spline. This window screen material is then wrapped around the window screen frame attached by adhesives to apply the functional capabilities and ornamental design throughout the completed product. This product can have a chosen designed image printed with the use of a wide format printer.

### FIELD OF THE INVENTION

This invention relates to multiple utility and ornamental design characteristics and improvements to the standard complete window screen function and design. More particularly, the One-Way Perforated vinyl (polyvinyl chloride) completed window screen with limited daylight privacy and with or without designed images (within and wrapped around the window screen frame) window screen improvements is the utility of the One-Way Perforated Vinyl (polyvinyl chloride) window vision film as a one single piece manufactured as a whole and this material is not mesh, metals, fiberglass, cloth, or any of these fibers or synthetic fibers coated with vinyl and is not a woven screening material in any form. This material is not a known window screening material used as the inner material of a standard window screen frame to make window screens. This material is similar to materials used for glass surfaces. The material One-way Perforated Vinyl (polyvinyl chloride) window film has the functionality of One-Way viewing, anti-U.V. protection, and the usage of eco-solvent and U.V. reflective printing inks with use of high definition wide format printers. This material blocks up to 99% of U.V. rays and has the functionality to let airflow pass through material with the function of the perforation rate. The perforation rate can be but not limited to: 50% to 70%. The One-Way Perforated Vinyl (polyvinyl chloride) window screen material is manufactured as a one single piece without use of other window screening materials and techniques and is attached to a standard window screen frame that consist of different materials and is inserted into a recessed groove within the window screen frame. The window screen spline is inserted into the recessed groove within the window screen frame to hold the One-Way Perforated Vinyl (polyvinyl chloride) window screen material with limited daylight privacy and designed images to the window screen frame and is then wrapped around the frame and covers the window screen frame with the use of adhesives to fasten the window screening material to the surface of the frame to keep ornamental design and functional flow throughout the window screen product.

### BACKGROUND OF THE INVENTION

Most of all window screens are manufactured by woven materials such as but not limited to: fiberglass, aluminum, and other woven composite materials. This product One-Way Perforated vinyl (polyvinyl chloride) completed window screen with limited daylight privacy and with or without designed images (within and wrapped around the window screen frame) uses the material of perforated vinyl (polyvinyl chloride as one single piece that is not woven and does not have any horizontal or vertical squared woven lines. This material does not consist of other related screening materials in use that uses a coated mesh from metals and fibers to create an illusion of a single piece material. The process of manufacturing does not include an image printed on a known use of window screening material that is offered today. There is no gluing, laminating, or any other pasted method to put an image on the window screening materials or meshes or metals that are woven to create a window screen used today. One-Way Perforated vinyl (polyvinyl chloride) completed window screen with limited daylight privacy and with or without designed images (within and wrapped around the window screen frame) is used itself only as the window screening material and is not a separate material from the inner window screen. The images are infused as the inner window screening material and the image is not applied by pasting, gluing, attaching, laminating, or by weaving the image in but is printed on One-way Perforated Vinyl (polyvinyl chloride) window film and is then inserted into a recessed groove within the standard window screen frame that is either composed of metal or plastic and the screen material is then wrapped around this frame and applied to by adhesives to continue the ornamental design and functionality throughout the completed window screen product. This material is not applied to any window screen material in use and the perforated polyvinyl chloride is used to standard window testing to act as the window screening material itself such as other window screening material manufactures that are similar do not use images in this exact process within a completed standard window screen. This material does not use fabricated vertical and horizontal wire mesh or is it woven by any other composite fiber or any synthetic fibers or any type of wired materials. The One-Way Perforated Vinyl (polyvinyl chloride) window vision film is manufactured to any specific size and dimensions and is formulated as a single one piece. The One-Way Perforated vinyl (polyvinyl chloride) completed window screen with limited daylight privacy and with or without designed images (within and wrapped around the window screen frame) is designed for limited daylight privacy whereas the owner's view is uncompromised when compared to any other composite screening material. This One-Way material restricts the outside view looking inward which gives added daylight privacy and the view of an image of unlimited designs. Also the One-Way Perforated Vinyl (polyvinyl chloride) vision film material is in itself energy efficient and lowers energy cost by blocking up to 99% of U.V. rays without use of inks. The designed one-way window screening material is stretched and attached to the window frame with window spline and then is wrapped around the frame itself to continue the printed design imaging onto the frame itself. This product is not a standard window screening material or design and has multi-functional ornamental designed uses and benefits and is not related to the standard window screen or others by definition of manufactured material. One-Way Perforated vinyl (polyvinyl chloride) completed window screen with limited daylight privacy and with or without designed images (within and wrapped around the window screen frame) can be printed with all color ranges including but not limited to solid basic colors such as grey, black, silver, brown, green, yellow, orange, blue, red, purple, white, and etc. One-Way Perforated vinyl (polyvinyl chloride) completed window screen with limited daylight privacy and with or without designed images (within and wrapped around the window screen frame) reduces glare by reflecting the suns U.V. rays.

### BRIEF SUMMARY OF THE INVENTION

The materials used in the invention of the One-Way Perforated vinyl (polyvinyl chloride) completed window screen with limited daylight privacy and with or without designed images (within and wrapped around the window screen frame) are One-Way Perforated Vinyl (polyvinyl chloride) Vision Film and window screen frame with window spline inserted into a recessed groove within the window screen frame to attach inner screen material used to frame. The inner material used in the invention is manufactured as a one piece and again is not woven with any other window screening materials and is not associated with or related to any vinyl covered fiber or metal meshes for desired effects. The use of designed images printed on the window screening material is printed by a high definition color wide format printer with the use of eco-solvent and anti-U.V. reflective inks. The printer used is a high definition wide format printer and can print any designed images onto the window screening material with any size and dimensions of material. The materials used reflect sunlight and U.V. Rays which also give added daylight privacy for users and designed images are but not limited to: landscapes, animals, seasonal, holidays, personal photographs agreed upon, and all pictures and photos and images allowable according to rights reserved and according to laws.

### BRIEF DESCRIPTION OF THE DRAWINGS

FIG. 1—As shown is from a close up inside view of the material used as the inner part of a window screen and frame and shows the perforation within completed window screen without printed image.

FIG. 2—As shown is from a side angle view of placing the inner window screen material and the process of attaching to window screen frame.

FIG. 3—As shown is from the inside view that does not show a printed image. This view shows the functionality of the material used that the view from this angle is not compromised or restricted.

FIG. 4—As shown is from the outside view that does have ornamental chosen designed image. This is the outside view of the complete window screen looking in.

FIG. 5—As shown is from a close up view of the functional material without image to illustrate the use of a one single piece and that this material is in fact not that woven or mesh.

FIG. 6—As shown from the outside view looking in that shows the ornamental design of a chosen image. This viewing angle illustrates the functionality of the material and shows that this view is compromised and is restricted as described to illustrate the functionality of the limited daylight privacy.

FIG. 7—As shown is a front angled view of the product material used to make the inner window screen that the ornamental chosen design images are printed on. Also this front angled view illustrates the function of the material as a single piece.

FIG. 8—As shown and illustrated from the outside view of ornamental design imaging on completed window screen that the frame under the attached material with spline is wrapped around the frame to continue the ornamental design and functionality throughout the completed product as a whole.

### DETAILED DESCRIPTION DRAWINGS

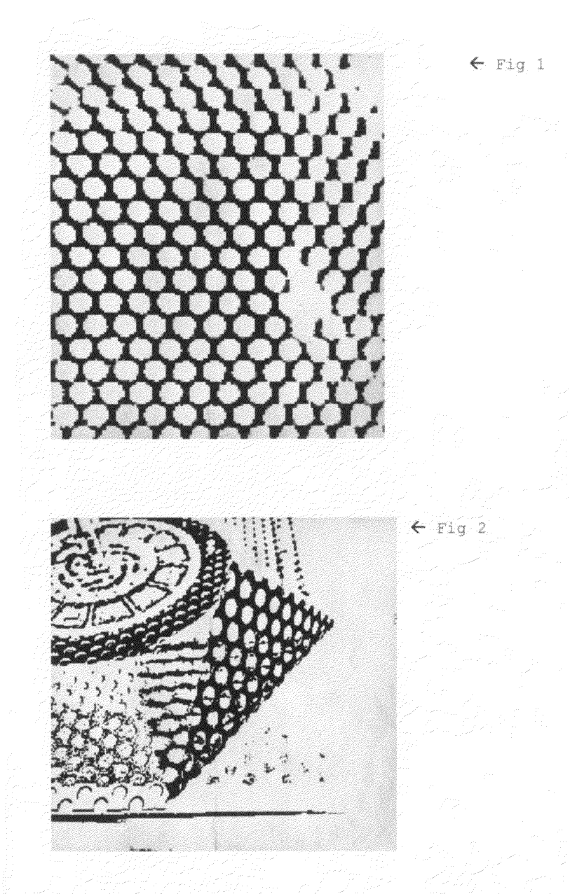

FIG. 1—What is shown in this illustration is the view of the material to show that the One-Way Perforated Vinyl (polyvinyl chloride) window screen is in fact one single piece to manufacture this completed window screen. This illustration shows that the material is not woven or a mesh that is used in similar utility window screen products. This illustration shows a 50% perforation rate that allows the designed airflow.

FIG. 2—What is shown in this illustration is the view of the perforated material that has the chosen ornamental design that of a motorcycle wheel. What is also shown as a characteristic is the perforation with design implemented.

FIG. 3—What this illustration shows is the viewing side without a printable image and shows the function that the view doesn't show the image on the other side. This view illustrates the functional characteristic of the view being uncompromised and unrestricted which gives the limited daylight privacy. As shown is a vehicle that is parked on other side of window screen product and is not a part of the design other than it illustrates the functional characteristic of uncompromised and unrestricted viewing capabilities that attributes to the limited daylight privacy function.

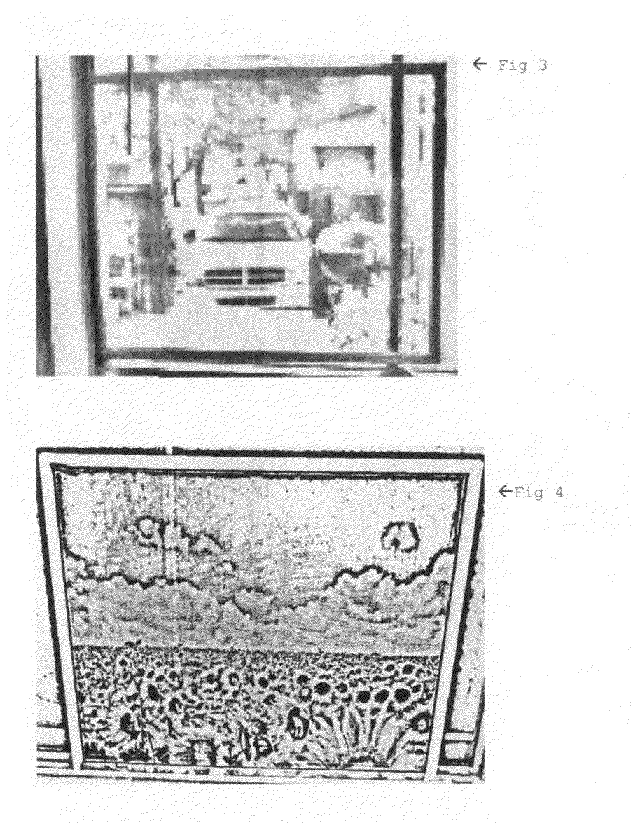

FIG. 4—What this illustration shows is the view from the other side of same window screen shown in FIG. 3. What is shown in this illustration is the view of completed ornamental design and function which shows a designed image of a field of sunflowers and sky of blue and that the view from this side of window screen product is compromised and also restricted and applies to the functional characteristic of the limited daylight privacy.

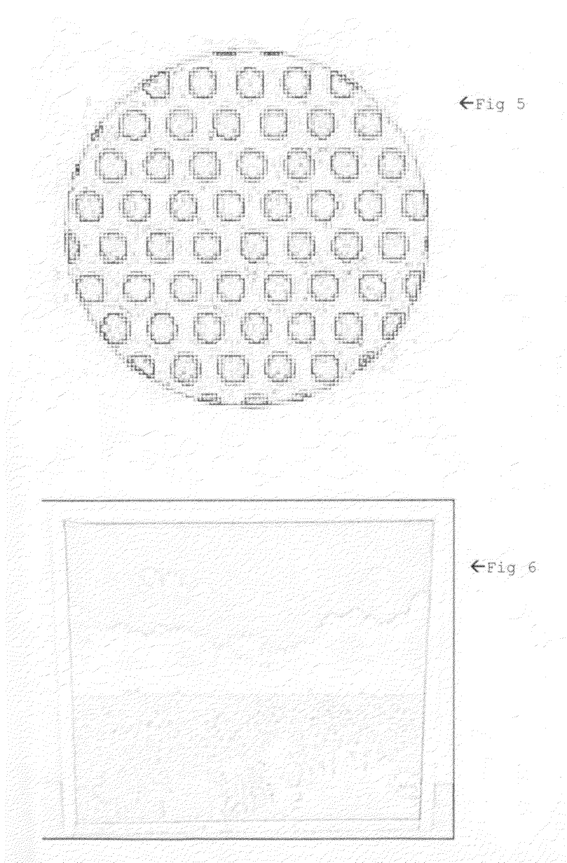

FIG. 5—What is shown in this illustration is a close up view of the window screen material that is not does not have an image and illustrates how this design and function of the inner part of the window screen product is a manufactured single piece and does not consist of woven material of any type of fiber or synthetic fiber mesh as in similar ornamental designed and utility window screens.

FIG. 6—What is shown in this illustration is the ornamental design and functional characteristics of the inner window screen material attached to the window screen to formulate as the completed window screen product. The image is that of a Sunflower field design and sky.

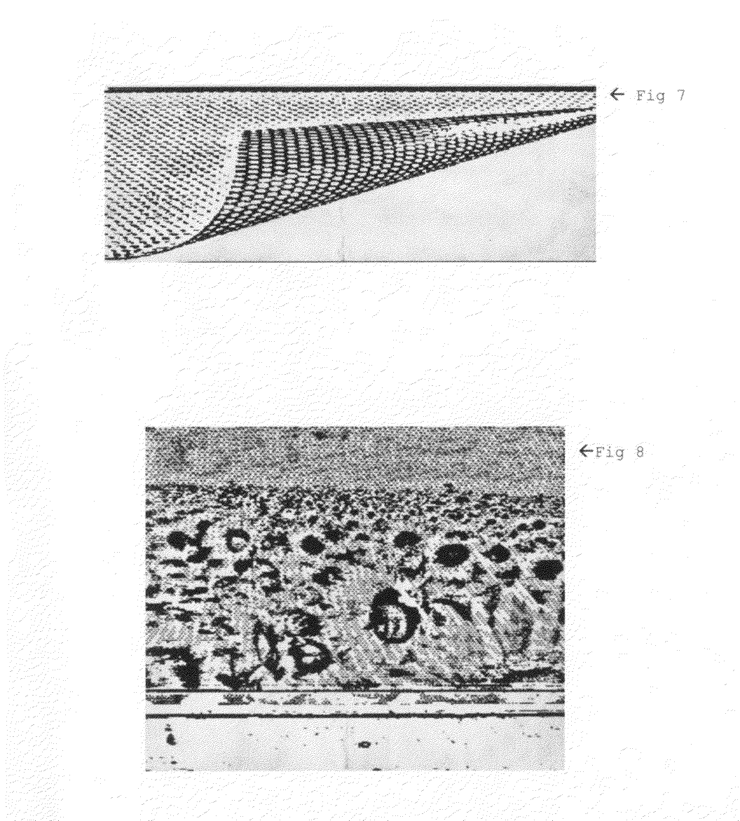

FIG. 7—What is shown in this illustration is the One-Way Perforated Vinyl (polyvinyl chloride) Vision window film material before it is used into the window screen frame. Once image design printed and this material is attached to window screen frame and the material is wrapped around the frame to continue the design onto the window screen frame (as shown and described by description FIG. 8) and it is completed as a product titled: One-Way Perforated vinyl (polyvinyl chloride) completed window screen with limited daylight privacy and with or without designed images (within and wrapped around the window screen frame).

FIG. 8—What is shown in this illustration is the use of the window screen material wrapped around the window screen frame as shown in the bottom of the illustration. The continuation of the material with or without design to cover the window screen frame with or without image of that of the inner screen material is part of the functionality use and ornamental design characteristics.

What is claimed is:

1) A functional complete window screen and frame comprising of One-Way Perforated Vinyl (polyvinyl chloride) Vision Film with a perforation composite of 50% to 70% which allows airflow passages and a proven barrier for insects. The use of the One-Way Perforated Vinyl (polyvinyl chloride) vision film as the window screen material within a window screen frame blocks 99% of U.V. rays and can be enhanced by a chosen printed ornamental design with a high definition wide format printer with Eco-Solvent and U.V. reflective inks which adds to the functional characteristics of the finished complete window screen and its energy efficiency. The ornamental design characteristic that is added to the functionality of this finished complete window screen is the resolution capability of images that are but not restricted to: 720-1080 high definition resolution and uses all ranges of colors. The finished complete window screen can be coated with illumination or glow in the dark inks that allow the functionality characteristic of night time viewing capabilities. This One-Way Perforated Vinyl material used in the finished complete window screen does not compromise or restricts viewing capabilities from one side and does compromise and restrict the viewing capabilities from the other side. This is the functional characteristic of the limited daylight privacy with or without a chosen image. With the use of inks mentioned, the functional characteristics are the limited daylight privacy, anti-U.V. ray reflective protection, and energy efficiency. The window frame structure that holds this window screen material has a standard recessed groove that retains this multi-functional screen material with window spline. The printable window screen material is then wrapped around the window screen frame and applied to by the use of adhesives to keep functional characteristics throughout this product. The completed product is then treated and coated with a weather proof clear coat sealant that is also water proof to add to the life span of the window screen product. The product as a whole can be manufactured to any size and to any dimensions followed by the descriptions and are not limited.

2) One-Way Perforated vinyl (polyvinyl chloride) completed window screen with limited daylight privacy and with or without designed images (within and wrapped around the window screen frame) screening material according to claim 1 wherein the materials used is One-Way Perforated Privacy Vision Film with or without illumination, with or without glow in the dark inks, and is a material derived from polyvinyl chloride.

3) One-Way Perforated vinyl (polyvinyl chloride) completed window screen with limited daylight privacy and with or without designed images (within and wrapped around the window screen frame) window screening material according to claim 1 wherein the vertical and horizontal One-Way Perforated Vinyl (polyvinyl chloride) vision film used as the window screening material is made of a perforation rate of 50% to 70% to allow non-restricted airflow while allowing a barrier for insects and that the window screening material is in fact a single manufactured material and is not woven, cloth, mesh, or a coated fiber or metal woven mesh, and is not a coated fiber or coated synthetic fiber that may resemble a single piece. This single piece of window screening material is the inner window screen of the finished complete window screen and is manufactured as such.

4) One-Way Perforated vinyl (polyvinyl chloride) completed window screen with limited daylight privacy and with or without designed images (within and wrapped around the window screen frame) according to claim 1 wherein the designed images printed on the One-Way Perforated Vinyl (polyvinyl chloride) vision film window screening material is but not limited to: landscapes, animals, all photos and pictures allowable by law, beach, seasonal, holidays, and any personal photos and pictures agreed upon. This is also stated that the single piece of window screening material is wrapped around the window screen frame to keep the functional characteristics and ornamental design characteristics throughout the complete finished window screen and frame product.

5) One-Way Perforated vinyl (polyvinyl chloride) completed window screen with limited daylight privacy and with or without designed images (within and wrapped around the window screen frame) according to claim 1 wherein the materials of the inner window screen are treated and coated with a clear weather protection for everyday outside use and to expand the lifespan of product which is a functional characteristic of finished product.

6) One-Way Perforated vinyl (polyvinyl chloride) completed window screen with limited daylight privacy and with or without designed images (within and wrapped around the window screen frame) according to claim 1 wherein the finished window screen product and frame is but not limited by any size or dimensions and can be made to any size for window screen usage.

7) One-Way Perforated vinyl (polyvinyl chloride) completed window screen with limited daylight privacy and with or without designed images (within and wrapped around the window screen frame) according to claim 1 wherein the eco-solvent and anti-U.V. reflective inks used to print images with high definition wide format printer reflects U.V. rays and direct sunlight and declares that usage is ecofriendly and energy efficient and is a functional characteristic of the finished window screen product. Also according to claim 1 wherein states that the one single piece of One-Way Perforated Vinyl (polyvinyl chloride) vision film used as the inner screen material itself is manufactured to block up to 99% of U.V. rays without the use of inks mentioned and is a functional characteristic of finished window screen product.

8) One-Way Perforated vinyl (polyvinyl chloride) completed window screen with limited daylight privacy and with or without designed images (within and wrapped around the window screen frame) according to claim 1 wherein that all designed images are but not limited to: high definition with 720-1080 resolution and uses all color ranges that reflects sunlight and is a functional characteristic of finished window screen product with frame.

9) One-Way Perforated vinyl (polyvinyl chloride) completed window screen with limited daylight privacy and with or without designed images (within and wrapped around the window screen frame) according to claim 1 wherein the window framing screening material and window screen frame is unrestricted to any size and dimensions. This finished complete window screen product with frame does not claim any usage other than a functional designed window screen and frame.
